(19) United States
(12) Patent Application Publication
(10) Pub. No.: US 2018/0107170 A1
(43) Pub. Date: Apr. 19, 2018

(54) ELECTRIC MOTOR DRIVE CONTROL SYSTEM AND DRIVING INSTRUCTION METHOD OF ELECTRIC MOTOR DRIVE CONTROL DEVICE

(71) Applicant: KABUSHIKI KAISHA YASKAWA DENKI, Kitakyushu-shi (JP)

(72) Inventors: Koji IWAHASHI, Kitakyushu-shi (JP); Satoshi SUESHIMA, Kitakyushu-shi (JP); Yasushi KIBE, Kitakyushu-shi (JP); Takeshi UEDA, Kitakyushu-shi (JP)

(73) Assignee: KABUSHIKI KAISHA YASKAWA DENKI, Kitakyushu-shi (JP)

(21) Appl. No.: 15/843,432

(22) Filed: Dec. 15, 2017

Related U.S. Application Data
(63) Continuation of application No. PCT/JP2017/016442, filed on Apr. 25, 2017.

(30) Foreign Application Priority Data
Sep. 30, 2016 (JP) 2016-194835

(51) Int. Cl. G05B 9/03; H02P 3/06; G05B 99/00; H02P 6/06

(52) U.S. Cl. CPC G05B 9/03; H02P 3/06; H02P 2207/05; H02P 6/06; G05B 99/00

(57) ABSTRACT

An electric motor drive control system includes an electric motor drive control device, a manual command device connected to the electric motor drive control device, a radio that performs radio communication with a telecommunication device that is a radio connection destination, and processing circuitry that sets a radio communication mode in which the radio responds to a radio connection request from the telecommunication device to establish a radio connection, the radio communication mode being set when the manual command device issues no manual command.

### CROSS-REFERENCE TO RELATED APPLICATIONS

The present application is a continuation of and claims the benefit of priority to International Application No. PCT/JP2017/016442, filed Apr. 25, 2017, which is based upon and claims the benefit of priority to Japanese Application No. 2016-194835, filed Sep. 30, 2016. The entire contents of these applications are incorporated herein by reference.

### BACKGROUND OF THE INVENTION

### Field of the Invention

The present invention relates to an electric motor drive control system and a driving instruction method of an electric motor drive control device.

### Description of Background Art

An electric motor drive inverter is a device capable of controlling the number of rotations of an electric motor freely. A servo controller may be used as a device capable of controlling the position and speed of an electric motor freely, and the electric motor controlled by the servo controller is referred to as a servo motor.

### SUMMARY OF INVENTION

According to one aspect of the present invention, an electric motor drive control system includes an electric motor drive control device, a manual command device connected to the electric motor drive control device, a radio that performs radio communication with a telecommunication device that is a radio connection destination, and processing circuitry that sets a radio communication mode in which the radio responds to a radio connection request from the telecommunication device to establish a radio connection, the radio communication mode being set when the manual command device issues no manual command.

According to another aspect of the present invention, a driving instruction method implemented by an electric motor drive control system includes performing switching to a radio communication mode when a manual command is not issued for a certain period of time in a switch operation mode, permitting, in the switch operation mode, a driving instruction to an electric motor drive control device to be issued with the manual command, and performing, in the radio communication mode, a response to a radio connection request from a telecommunication device through radio communication to establish a radio connection. The electric motor drive control system includes the electric motor drive control device and a manual command device connected to the electric motor drive control device.

According to yet another aspect of the present invention, a mode setting apparatus includes memory, and processing circuitry that sets a radio communication mode in which a radio, performs radio communication with a telecommunication device that is a radio connection destination, responds to a radio connection request from the telecommunication device to establish a radio connection. The radio communication mode is set when a manual command device, connected to an electric motor drive control device, issues no manual command.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a view of a system configuration for electric motor control, including an electric motor drive control system according to a first embodiment of the present invention;

FIG. 2 is an external view of an operation terminal;

FIG. 3 is a functional block diagram of the electric motor drive control system;

FIG. 4 is a diagram of a basic hardware configuration of an information processing device;

FIG. 5 is a diagram of the flow of information in the electric motor drive control system in a switch operation mode;

FIG. 6 is a view of an exemplary state where, in the switch operation mode, an image generated by an electric motor drive control device, has been displayed on an information display screen of the operation terminal and an indicator has turned on;

FIG. 7 is a diagram of the flow of information in the electric motor drive control system in a radio communication mode;

FIG. 8 is a view of an exemplary state where, in the radio communication mode, an image generated by a controller has been displayed on the information display screen of the operation terminal and an image generated by the electric motor drive control device has been displayed on a telecommunication device;

FIG. 9 is a diagram for describing conditions in which switching is performed between the operation modes of the operation terminal according to the present embodiment and the direction of the switching;

FIG. 10 is a flowchart of the operation of a mode setting unit in performing the mode switching in the switch operation mode;

FIG. 11 is a flowchart of the operation of the mode setting unit in performing the mode switching in the radio communication mode;

FIG. 12 is a flowchart of the operations of a radio communication unit and the telecommunication device in establishing radio communication in the radio communication mode;

FIG. 13 is a functional block diagram of an electric motor drive control system according to a second embodiment of the present invention;

FIG. 14 is a view of a system configuration for electric motor control, including an electric motor drive control system 1 according to a third embodiment of the present invention; and

FIG. 15 is a functional block diagram of the electric motor drive control system according to the third embodiment of the present invention.

### DETAILED DESCRIPTION OF THE EMBODIMENTS

Embodiments will now be described with reference to the accompanying drawings, wherein like reference numerals designate corresponding or identical elements throughout the various drawings.

### First Embodiment

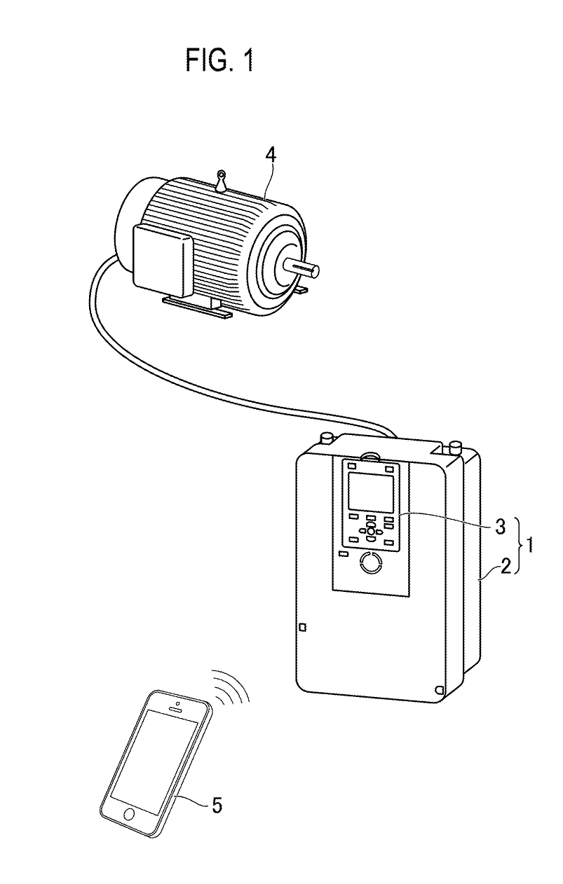

FIG. 1 is a view of a system configuration for electric motor control, including an electric motor drive control system 1 according to a first embodiment of the present invention.

The figure schematically illustrates an electric motor drive control device 2 and an operation terminal 3 included in the electric motor control system 1, an electric motor 4 that is connected to the electric motor drive control device 2 and is controlled in driving, stopping, and the number of rotations during the driving by the electric motor drive control device 2, and a telecommunication device 5 that performs radio communication with the operation terminal 3.

Here, the electric motor drive control device 2 includes a device generally referred to as an (electric motor drive) inverter, and typically includes the device including an inverter circuit that converts a commercial alternating-current power source or direct current power source into a variable frequency three-phase alternating current, the device being suitable for arbitrarily controlling the number of rotations of the electric motor 4 and driving the electric motor 4. The inverter circuit used in the electric motor drive control device 2, may include a general voltage source inverter, or may include a current source inverter or a different type of circuit. The electric motor drive control device 2 described in the present specification at least arbitrarily controls the number of rotations of the electric motor 4 and drive the electric motor 4. Examples of the electric motor drive control device 2 include a device used for drive control of a servo motor, the device being referred to as a servo controller (or a servo amplifier), in addition to the (electric motor drive) inverter exemplified in the present embodiment.

The operation terminal 3 includes a small-sized terminal device through which a user performs various operations to the electric motor drive control device 2 or displays the internal state of the electric motor drive control device 2, the terminal device being physically connected to the electric motor drive control device 2.

According to the present embodiment, the electric motor drive control device 2 includes the (electric motor drive) inverter, and the operation terminal 3 includes a so-called keypad attached to the front face of the electric motor drive control device 2, the keypad being detachable. In FIG. 1, the operation terminal 3 engages with a recess portion provided on the front face of the electric motor drive control device 2 so that the operation terminal 3 is retained as if to be integrally formed with the electric motor drive control device 2. At this time, connecting a connector provided to the electric motor drive control device 2 and a connector provided to the operation terminal 3, physically connects the two to enable an exchange of electric signals each other. Instructions from the user for the various operations to the electric motor drive control device 2 are issued and a display of information is performed through the operation terminal 3. The connectors of the two are connected through an appropriate electric cable so that the operation terminal 3 can be used approximately a few meters apart from the electric motor drive control device 2. A detailed configuration of the operation terminal 3 will be described later, but, according to the present specification, examples of the operation terminal 3 include the keypad to the (electric motor drive) inverter and a digital operator to the servo controller.

The electric motor 4 includes an alternating-current electric motor driven by the electric motor drive control device 2. The type of the electric motor 4 is not particularly limited, and thus a general induction motor, a synchronous reluctance motor, a surface magnet type synchronous motor, or a built-in magnet type synchronous motor may be provided.

The telecommunication device 5 includes a so-called information terminal having a radio communication function, and may include, for example, a smartphone as illustrated in FIG. 1. The telecommunication device 5 may include a different information terminal, and thus may include a mobile phone, a PDA, a tablet computer, or a general laptop computer or desktop computer. The telecommunication device 5 establishes radio connection with the operation terminal 3 through the radio communication, and is used remotely to issue the instructions for the various operations to the electric motor drive control device 2 or to perform the display of the information as if the operation terminal 3 is operated on the telecommunication device 5.

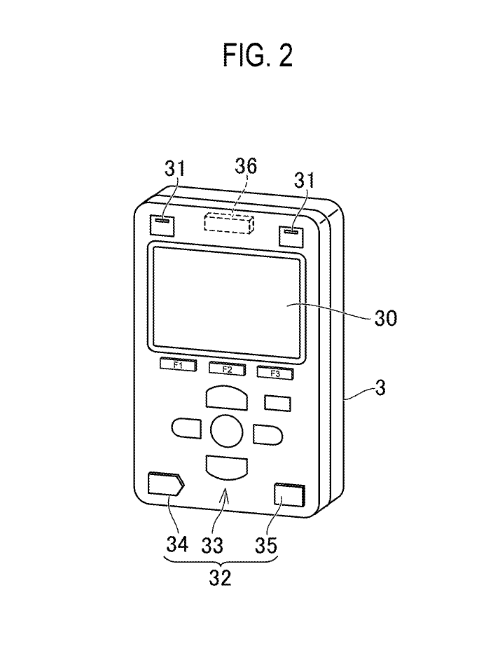

FIG. 2 is an external view of the operation terminal 3. An information display screen 30, an indicator 31, and an operation switch 32 are arranged on the front face of the operation terminal 3. A radio communication unit 36 is provided to an appropriate position inside the operation terminal 3, namely, an upper portion in the example.

The information display screen 30 displays various types of information for the user, and may include a general dot matrix type flat display. The information display screen 30 may include, for example, a liquid crystal display or an organic EL display.

The indicator 31 is not necessarily required, but notifies the user of the basic state of the electric motor drive control device 2 in a state where the indicator 31 has turned on. The basic state of which the user is notified is not particularly limited, but examples of the basic state include the driving state, stopping state, and standby state of the electric motor drive control device, and an alarm display when an abnormality occurs. Each notification may be distinguished with a color of the indicator 31 that has turned on. In addition, the number of the indicators 31 is not limited to two as illustrated, and thus may be arbitrary.

The operation switch 32 allows the user to perform the various operations to the electric motor drive control device 2, an alteration in control parameters, and the display of the internal information. Here, the operation switch 32 includes a general-purpose switch group 33 that performs various operations in accordance with a combination of switch operations, such as a cross key and an enter key, or a display state on the information display screen 30, a driving switch 34 that issues an instruction for driving the electric motor (namely, the rotation), and a stopping switch 35 that issues an instruction for stopping the electric motor (namely, the rotation stop). The general-purpose switch group 33 may include a specific function switch other than the driving switch 34 and the stopping switch 35. The general-purpose switch group 33 is not necessarily provided to the front face of the operation terminal 3 as an independent switch, and thus may be achieved as a virtual switch on the information display screen 30 with the information display screen 30 including a touch panel.

The radio communication unit 36 includes a radio antenna and a communication controller, and enables the operation terminal 3 to perform information and communication with the telecommunication device 5 outside by radio. The communication standard of the radio communication with the radio communication unit 36, may adopt a particular technique, but may adopt an existing communication standard, and thus can adopt, for example, Bluetooth (registered trademark) or Wi-Fi (registered trademark). According to the present embodiment, Bluetooth (registered trademark) is adopted as the radio communication standard between the operation terminal 3 and the telecommunication device 5. Thus, descriptions will be given below on the basis of Bluetooth (registered trademark), but the radio communication standard is not limited to Bluetooth (registered trademark).

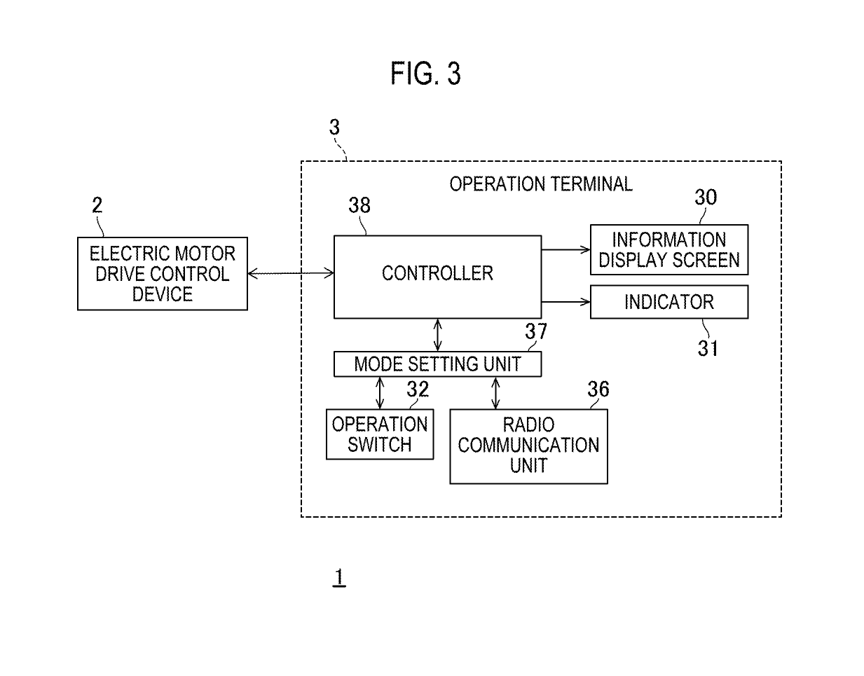

FIG. 3 is a functional block diagram of the electric motor drive control system 1. The operation terminal 3 includes a mode setting unit 37 and a controller 38 inside other than the information display screen 30, the indicator 31, the operation switch 32, and the radio communication unit 36, illustrated in FIG. 2.

The operation terminal 3 according to the present embodiment, has at least two modes including a radio communication mode and a switch operation mode as operation modes. The mode setting unit 37 sets an appropriate mode to the operation terminal 3 in accordance with the presence or absence of an operation from the user or other external conditions. The mode setting unit 37 retains the mode that has been set, and additionally the controller 38 to be described later may be notified of the mode.

Here, the operation modes of the operation terminal 3 each refer to the operation to be selected of the operation terminal 3 in a case where the operation of the operation terminal 3 varies in accordance with a main interface used when the user operates the operation terminal 3. The radio communication mode is appropriate when the user operates the telecommunication device 5 outside described above to remotely operate the operation terminal 3 through the radio communication. The switch operation mode is appropriate when the user directly operates the operation switch 32 of the operation terminal 3. The details of the radio communication mode and the switch operation mode will be described later.

The controller 38 includes an information processing circuit that controls the operation of the entire operation terminal 3. The controller 38 may include a general microcontroller, a dedicated information processing circuit, such as an application specific integrated circuit (ASIC), or a programmable logic device (PLD), such as a field programmable gate array (FPGA).

Particularly, the controller 38 controls the flow of information input from the operation switch 32 and information input and output with the radio communication unit 36 through the mode setting unit 37, information output to the information display screen 30 and the indicator 31, and information input and output with the electric motor drive control device 2, and additionally generates and outputs information as necessary. The function of the mode setting unit 37 may be achieved, as part of the function of the controller 38, by software.

According to the present embodiment, the operation terminal 3 and the electric motor drive control device 2 are mutually capable of performing information and communication, and transmit and receive necessary information through the controller 38.

The operation terminal 3 according to the present embodiment, is basically set in the radio communication mode, and switches to the switch operation mode when a particular operation to the operation switch 32 is performed. When no operation has been performed to the operation switch 32 for a certain period of time, for example, for five minutes, the mode setting unit 37 sets the radio communication mode. Thus, the operation terminal 3 remains in the radio communication mode unless the user consciously makes a switch to the switch operation mode otherwise.

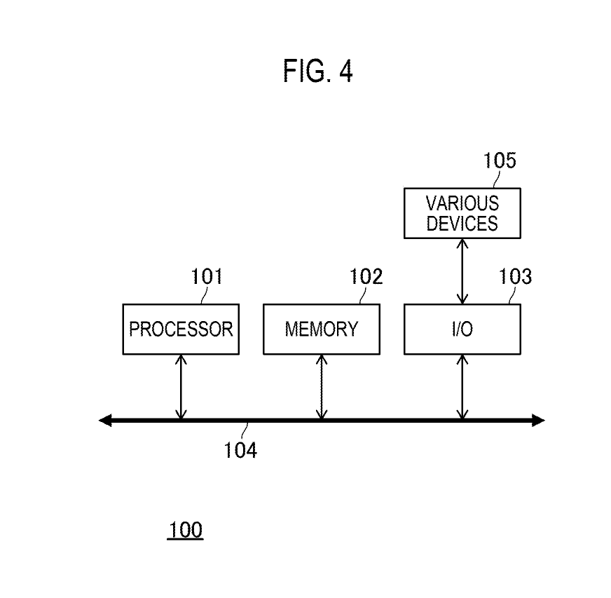

As described above, the electric motor drive control device 2, the operation terminal 3, and the telecommunication device 5 according to the present embodiment each have a basic configuration as a so-called information processing device 100. FIG. 4 is a diagram of the basic hardware configuration of the information processing device 100 included in each of the electric motor drive control device 2, the operation terminal 3, and the telecommunication device 5.

As illustrated in FIG. 4, the information processing device 100 has a configuration in which a processor 101, a memory 102, and an I/O 103 are connected to a bus 104 so as to be able to perform information and communication mutually. The processor 101 may include a general-purpose information processing circuit or a dedicated information processing circuit, similarly to the controller 38 of the operation terminal 3 described above. The memory 101 may include a volatile memory and a non-volatile memory. The volatile memory may include a general random access memory (RAM), and the non-volatile memory may include a read only memory (ROM) or an electrically erasable programmable read only memory (EEPROM). The I/O 103 includes an interface that connects the bus 104 and various devices 105 to enable information and communication to be performed mutually.

The various devices 105 are controlled by the information processing device 100. Some of the various devices 105 are directly built in the device having the configuration of the information processing device 100. For example, the information display screen 30, the indicator 31, the operation switch 32, and the radio communication unit 36 of the operation terminal 3 correspond to the some of the various devices 105. The remains of the various devices 105 are connected to the device having the configuration of the information processing terminal 100 from the outside. For example, for the operation terminal 3, the electric motor drive control device 2 corresponds to the remainder of the various devices 105.

However, the flow of the information and the operation in the electric motor drive control system 1 may be understood more easily with the switch operation mode. Thus, first, the flow of the information and the operation will be described in the switch operation mode.

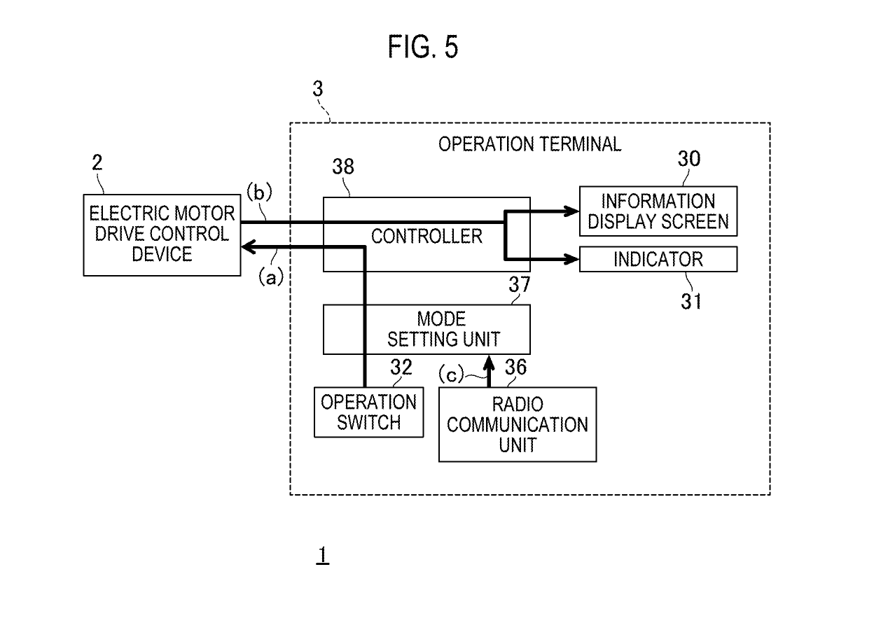

FIG. 5 is a diagram of the flow of the information in the electric motor drive control system 1 in the switch operation mode. The information on the operation performed to the operation switch 32 by the user, passes through the mode setting unit 37 so as to be transmitted to the electric motor drive control device 2 through the controller 38, as illustrated with (a).

The electric motor drive control device 2 performs an operation corresponding to the operation performed to the operation switch 32, for example, outputting and stopping of driving power to the electric motor 4 or an alteration in internal parameters. In addition, with respect to the operation performed to the operation switch 32, the electric motor drive control device 2 generates an image to be displayed on the information display screen 30 of the operation terminal 3 and generates information indicating the state to be indicated by the indicator 31, so as to transmit the image and the information to the controller 38 as illustrated with (b). The controller 38 displays the image generated by the electric motor drive control device 2, onto the information display screen 30 and turns the indicator 31 on or off so that the user is notified of the state received from the electric motor drive control device 2.

The image to be displayed on the information display screen 30 of the operation terminal 3, is not necessarily generated as a single body by the electric motor drive control device 2 as in the present embodiment. Examples of different methods of acquiring the image, that can be considered, include a method including: storing images to be displayed, previously into the electric motor drive control device 2; and selecting and transmitting an image to be displayed to the operation terminal 3, by the electric motor drive control device 2, a method including: storing information on the images to be displayed, previously into the operation terminal 3; and specifying an image to be display, by the electric motor drive control device 2, a method including: interpreting the operation of the user by the operation terminal 3 itself; and selecting an image to be displayed previously stored, by the operation terminal 3, and a method including: interpreting the operation of the user by the operation terminal 3 itself; and generating an image to be display, by the operation terminal 3. Alternatively, the methods may be appropriately combined. For example, part of the image to be displayed may be generated by the electric motor drive control device 2 so as to be transmitted to the operation terminal 3. Then, the operation terminal 3 may generate the remains of the image.

In the switch operation mode, the radio communication unit 36 turns the radio communication off so that no radio communication is performed, or, as described later, with a few exceptions, the mode setting unit 37 interrupts the information input from the radio communication unit 36 so that the information is not transmitted to the electric motor drive control device 2, as illustrated with (c). With this arrangement, the electric motor drive control device 2 cannot be operated, in principle, through the telecommunication device 5 outside, in the switch operation mode.

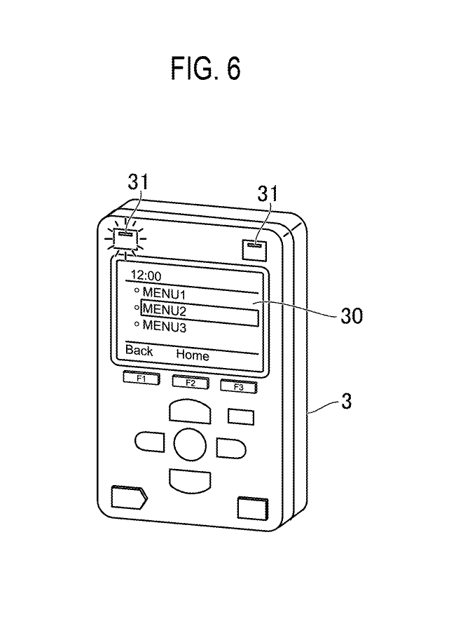

FIG. 6 is a view of an exemplary state where, in the switch operation mode, the image generated by the electric motor drive control device 2, has been displayed on the information display screen 30 of the operation terminal 3 and the indicator 31 has turned on. As illustrated in the figure, with the image generated by the electric motor drive control device 2 as a graphical user interface (GUI), the user can access each function included in the electric motor drive control device 2 and can refer to the information.

Except that the mode setting unit 37 performs pass control of the information, the switch operation mode according to the present embodiment, is similar to the operation of a keypad having no radio communication function. Particularly, the difference is not recognized when viewed through the electric motor drive control device 2.

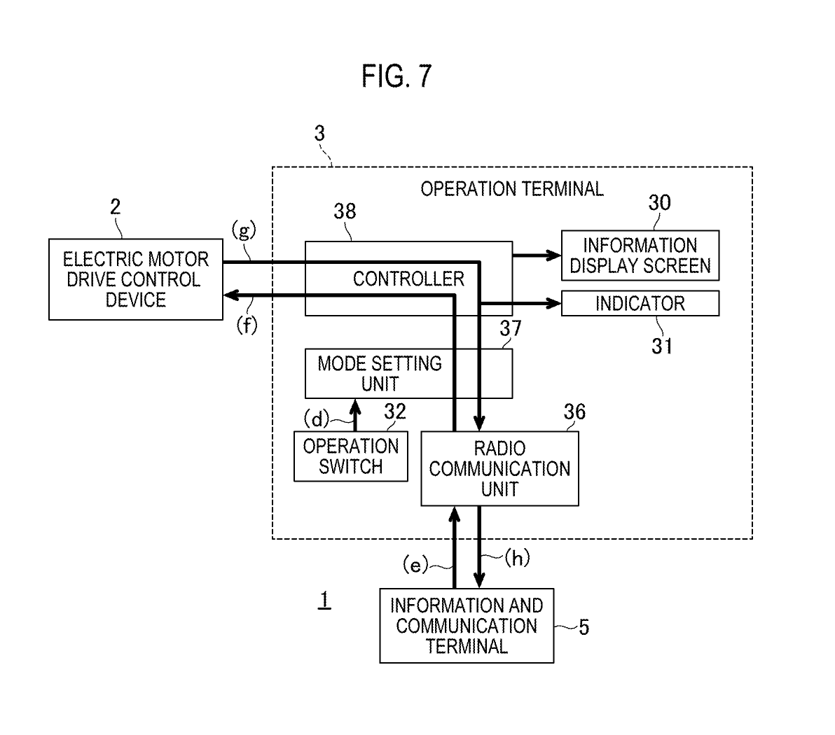

In contrast to this, the flow of the information and the operation in the radio communication mode, will be described next. FIG. 7 is a diagram of the flow of the information in the electric motor drive control system 1 in the radio communication mode. In the radio communication mode, as described later, with the few exceptions, the mode setting unit 37 interrupts the information on the operation performed to the operation switch 32 by the user as illustrated with (d) so that the information is not transmitted to the electric motor drive control device 2. With this arrangement, the electric motor drive control device 2 cannot be operated, in principle, through the operation switch 32, in the radio communication mode.

In contrast to this, in the radio communication mode, the radio communication is established between the radio communication unit 36 and the telecommunication device 5, and the operation of the user is performed to the telecommunication device 5 so as to be received. The information on the operation of the user received by the telecommunication device 5, is transmitted to the radio communication unit 36 through the radio communication, as illustrated with (e). Furthermore, the information passes through the mode setting unit 37 so as to be transmitted to the electric motor drive control device 2 through the controller 38 as illustrated with (f).

The operation in the electric motor drive control device 2, is similar to that in the switch operation mode above. That is, for the operation corresponding to the operation performed by the user, the image to be displayed on the information display screen 30 of the operation terminal 3, is generated and the information indicating the state to be indicated by the indicator 31, is generated so as to be transmitted to the controller 38 as illustrated with (g).

However, handling of the information received from the electric motor drive control device 2, in the controller 38, is different from that in the switch operation mode above. In the radio communication mode, the controller 38 transmits the image generated by the electric motor drive control device 2, to the radio communication unit 36 so that the image is transmitted to the telecommunication device 5 as illustrated with (h). Therefore, the image is displayed on the telecommunication device 5. With this arrangement, the user can operate the telecommunication device 5 as if directly operating the operation terminal 3. The controller 38 turns the indicator 31 on or off on the basis of the state received from the electric motor drive control device 2, but this is not necessarily required. Thus, the indicator 31 may be brought into a particular state (e.g., the indicator 31 fully turned off) for the radio communication mode or a display imitating the indicator 31, may be performed on the telecommunication device 5.

As in the description for the switch operation mode above, the image to be displayed on the telecommunication device 5, is not necessarily generated by the electric motor drive control device 2, in the radio communication mode. Any one or at least two of the electric motor drive control device 2, the information terminal 3, and the telecommunication device 5, may previously store the images to be displayed and an image to be displayed specified by any of the devices, may be displayed on the telecommunication device 5. Alternatively, any one or at least two of the electric motor drive control device 2, the information terminal 3, and the telecommunication device 5, may interpret the operation of the user so as to generate the image to be displayed. Alternatively, the methods may be combined, similarly. Furthermore, the image to be displayed on the information display screen 30 of the operation terminal 3 in the switch operation mode is not necessarily the same as the image to be displayed on the telecommunication device 5 in the radio communication mode, and thus the images may be different from each other in design.

Meanwhile, an image generated by the controller 38, is transmitted to and displayed on the information display screen 30 of the operation terminal 3, the image indicating that the radio communication mode has been selected. With this arrangement, the user who has viewed the operation terminal 3, can recognize that the electric motor drive control system 1 is currently in the radio communication mode.

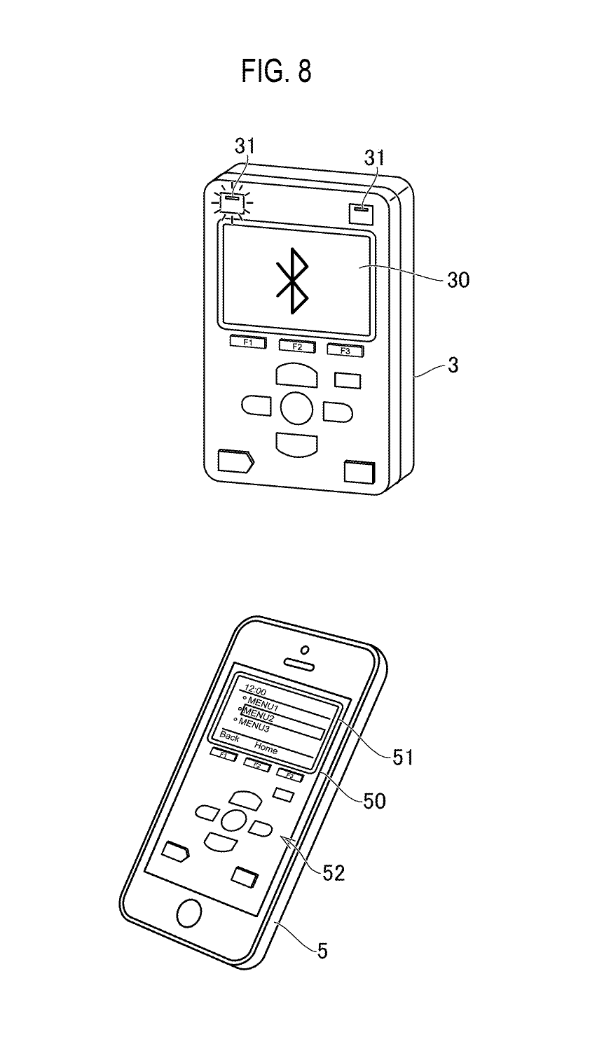

FIG. 8 is a view of an exemplary state where, in the radio communication mode, the image generated by the controller 38, has been displayed on the information display screen 30 of the operation terminal 3 and the image generated by the electric motor drive control device 2, has been displayed on the telecommunication device 5.

The image indicating that the radio communication mode has been selected (here, the logo of Bluetooth (registered trademark)), has been displayed on the information display screen 30 of the operation terminal 3. With this arrangement, the user can grasp that the operation terminal 3 is currently in the radio communication mode and, with the few exceptions, the electric motor drive control device 2 cannot be operated through the operation switch 32.

A region 51 imitating the information display screen 30 of the operation terminal 3, is provided onto a touch screen 50 of the telecommunication device 5, and the image generated by the electric motor drive control device 2 is displayed on the region. Furthermore, a region 52 on which an image imitating the operation switch 32 of the operation terminal 3 is displayed, is provided onto the touch screen 50. The user touches a virtual switch displayed on the region 52 so as to be able to operate the telecommunication device 5 as if directly operating the operation terminal 3.

Next, mode switching in the electric motor drive control system 1, will be described. The electric motor drive control system 1 according to the present embodiment, has the two modes including the radio communication mode and the switch operation mode as the operation modes of the operation terminal 3. The mode setting unit 37 acts to perform switching between the modes.

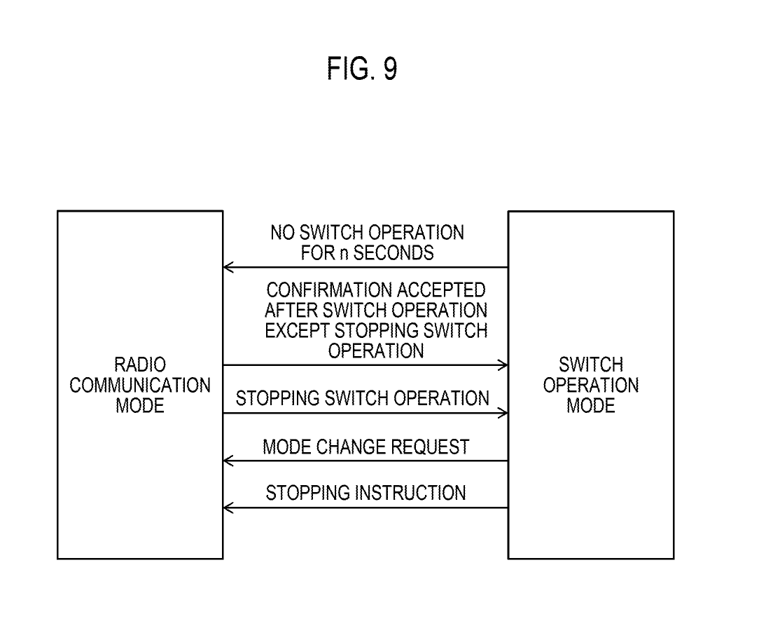

FIG. 9 is a diagram for describing conditions in which the switching is performed between the operation modes of the operation terminal 3 according to the present embodiment and the direction of the switching. Some of the conditions may be important and the others are arbitrary.

First, as an important switching condition, in a case where no operation has been performed to the operation switch 32 for the certain period of time (for n seconds) in the switch operation mode, the switching to the radio communication mode is automatically performed. With this arrangement, in a case where no particular operation is performed by the user, the operation terminal 3 is in the radio communication mode. Thus, the operation terminal 3 responds to a radio connection request from the telecommunication device 5 and remains on standby, being ready to establish the radio connection. Therefore, with no direct particular operation required to the operation terminal 3, the user uses the telecommunication device 5 to remotely establish the radio connection with the operation terminal 3 so that the electric motor drive control system 1 can be operated.

For example, in a case where the electric motor drive control system 1 has been provided to an unreachable high place or a place inconvenient to access, such as the far side of a device or a door, or in a case where multiple electric motor drive control systems 1 have been scattered in a wide range of farmland and the user patrols each electric motor drive control system 1, riding in a motor vehicle, the user is not required to ascend the high place or to get off the motor vehicle in order to arrive at the place at which the electric motor drive control system 1 has been provided, and thus can promptly operate the electric motor drive control system 1.

The certain period of time may be constantly a predetermined value or may be arbitrarily set by the user. According to the present embodiment, the certain period of time satisfies the following condition: n=30 seconds in an initial state. That is, when no operation has been performed to the operation switch 32 for 30 seconds, a transition is made from the switch operation mode to the radio communication mode. The particular operation to the operation switch 32 in the switch operation mode, may limit the transition from the switch operation mode to the radio communication mode. According to the present embodiment, in the switch operation mode, as the particular operation to the operation switch 32, pressing and holding an F2 key (e.g., for two seconds) from the general-purpose switch group 33, sets the following condition: n=600 seconds. That is, in the switch operation mode, the particular operation of pressing and holding the F2 key, limits the switching to the radio communication mode for 10 minutes. With this arrangement, inconvenience caused by frequent occurrence of the switching between the modes, can be avoided in making time-consuming work progress, such as initial settings to the electric motor drive control device 2. The switch 32 used for the particular operation is not necessarily the F2 key, and thus a different key in the switch 32 may be used.

Next, as a switching condition, in the radio communication mode, the particular operation of the operation switch 32 performs switching from the radio communication mode to the switch operation mode. As the particular operation, a single type of operation may be only allowed or at least two types of operations may be allowed. According to the present embodiment, two types of operations are allowed, the two types of operations including an operation with the stopping switch 35 and an operation with the switch 32 excluding the stopping switch 35, namely, an operation with the general-purpose switch group 33 or the driving switch 34.

First, the operation with the switch except the stopping switch 35, will be described. In a case where the operation with the switch 32 excluding the stopping switch 35, namely, any of the switches 32 included in the general-purpose switch group 33 and the driving switch 34, is performed, the switching to the switch operation mode is not performed immediately, but a confirmation display for the user to confirm the switching to the switch operation mode, is first performed onto the information display screen 30 of the operation terminal 3. When the user performs an operation meaning acceptance, to the confirmation display, the operation terminal 3 switches to the switch operation mode. In this manner, temporarily displaying a confirmation screen for the operation, inhibits the switching to the switch operation mode that has been undesired, from being performed in a case where an accidental operation has been performed, such as a wrong operation or pressing of the switch 32 due to a bump of a different object against the operation terminal 3.

The switching operation makes no operation request to the electric motor drive control device 2 and has no influence on the driving state of the electric motor 4. Thus, the switch operation is suitable in a case where the state of the electric motor drive control device 2 is desirably confirmed through the operation terminal 3 or in a case where an alteration in various parameters is desirably made. The operation switch 32 with which the switching operation is performed, is not necessarily set to the entire operation switch 32 excluding the stopping switch 35, and may be limited to one particular switch or multiple switches in the operation switch 32.

In contrast to this, in the operation with the stopping switch 35, when the stopping switch 35 is pressed, the operation terminal 3 immediately switches to the switch operation mode and information on the effect that the stopping switch 35 has been pressed is transmitted to the electric motor drive control device 2 so that the electric motor 4 stops. This is because the intention of stopping the electric motor 4 is important and is desirably and preferentially accepted, and thus the intention is immediately reflected. That is, the operation to the stopping switch 35 is effectively received even in the radio communication mode.

In the switch operation mode, in a case where the radio connection with the telecommunication device 5 has been retained, the switch operation mode may be switched to the radio communication mode on the basis of a particular request from the telecommunication device 5.

For example, a particular operation (e.g., selection of a particular menu on a GUI) is performed on the telecommunication device 5 so that the mode setting unit 37 is notified of a mode change request through the radio communication unit 36. Then, the switching to the radio communication mode may be made. This operation forcibly enables the switching to the radio communication mode in a case where the switching to the radio communication mode has been limited due to, for example, the particular operation to the operation switch 32 described above (the pressing and holding of the F2 key).

Alternatively, in a case where the intention of stopping the electric motor 2 has been indicated on the telecommunication device 5, such as a case where the stopping switch has been selected on the GUI in the telecommunication device 5, when the mode setting unit 37 is notified of a stopping instruction being information indicating the operation, the switching to the radio communication mode may be performed immediately. With this arrangement, information on the effect that the stopping instruction has been issued, is transmitted to the electric motor drive control device 2 so that the electric motor 4 stops. This is because the intention of stopping the electric motor 4 indicated by the user is desirably prioritized.

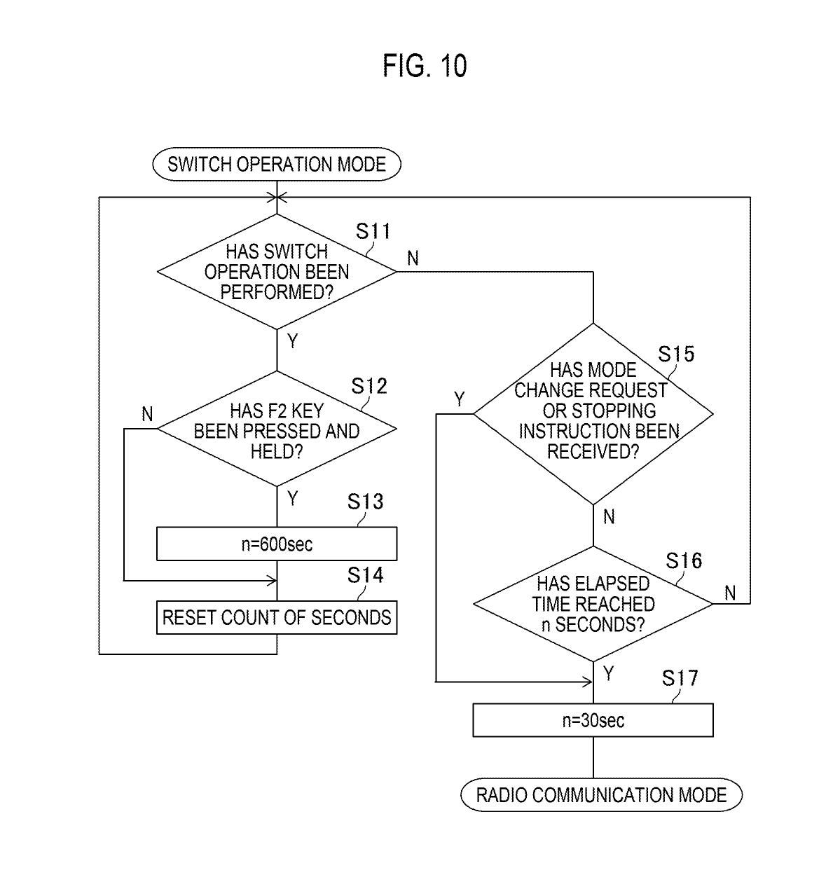

FIG. 10 is a flowchart of the operation of the mode setting unit 37 in performing the mode switching in the switch operation mode.

At step S11, the mode setting unit 37 determines whether a switch operation has been performed to the operation switch 32, in a case where the operation terminal 3 is in the switch operation mode. In a case where the switch operation has been performed (S11: Y), the processing proceeds to step S12 and then the mode setting unit 37 determines whether the switch operation is the pressing and holding of the F2 key. In a case where the switch operation is the pressing and holding of the F2 key (S12: Y), the processing proceeds to step S13 and then the period of time n of the switching to the radio communication mode with no operation is set to 300 seconds so that the transition from the switch operation mode to the radio communication mode is limited. In a case where the switch operation is not the pressing and holding of the F2 key (S12: N) and after step S13, the processing proceeds to step S14 and then elapsed time in the switch operation mode, namely, the count of seconds is reset to zero. Then, the processing goes back to step S11. With this arrangement, as long as the switch operation continues until n seconds elapses, the operation terminal 3 remains in the switch operation mode.

Meanwhile, in a case where no switch operation has been performed (S11: N), the processing proceeds to step S15 and then the mode setting unit 37 determines whether the mode change request or the stopping instruction has been received from the telecommunication device 5 in the radio connection. In a case where no mode change request or no stopping instruction has been received or in a case where no telecommunication device 5 in the radio connection is present (S15: N), the processing proceeds to step S16 and the mode setting unit 37 further determines whether the elapsed time in the switch operation mode has reached n seconds. In a case where the elapsed time has not reached n seconds yet (S16: N), the processing goes back to step S11 and the switch operation mode continues.

In contrast to this, in a case where the elapsed time has reached n seconds (S16: Y) and in a case where the mode change request or the stopping instruction has been received from the telecommunication device 5 in the radio connection (S15: Y), the processing proceeds to step S17 and the period of time n of the switching to the radio communication mode with no operation, is set back to 30 seconds being the initial value. Then, the switching to the radio communication mode is performed.

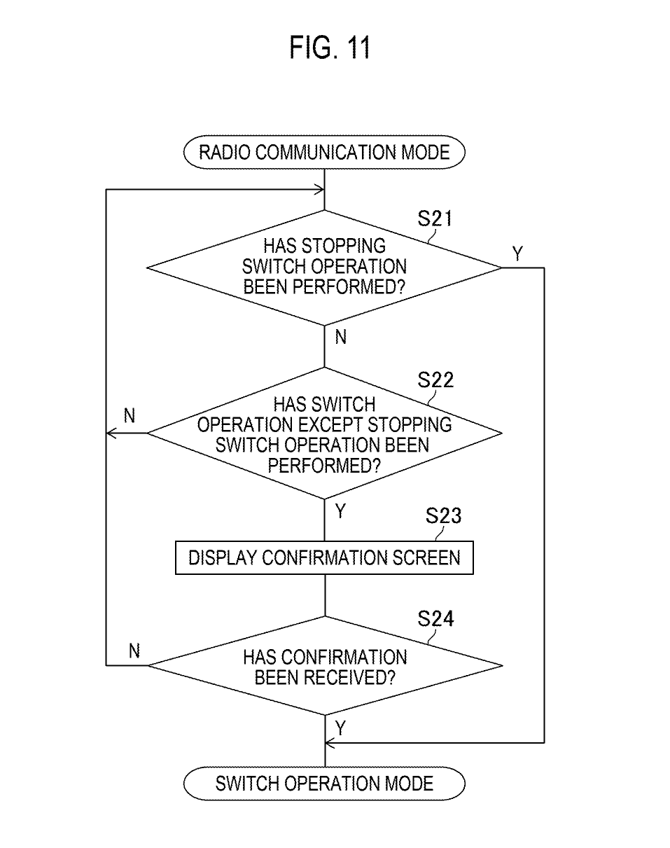

FIG. 11 is a flowchart of the operation of the mode setting unit 37 in performing the mode switching in the radio communication mode.

At step S21, the mode setting unit 37 first determines whether the operation to the stopping switch 35 has been performed as the particular operation to the operation switch 32, in a case where the operation terminal 3 is in the radio communication mode. Here, in a case where the operation has been performed (S21: Y), the switching to the switch operation mode is immediately performed. With this arrangement, the operation to the stopping switch 35 is received, similarly to the operation performed in the switch operation mode.

In a case where no operation has been performed to the stopping switch 35 (S21: N), the processing proceeds to the following step S22. The mode setting unit 37 determines whether the operation to the operation switch 32 excluding the stopping switch 35, namely, to any of the switches 32 included in the general-purpose switch group 33 and the driving switch 34, has been performed. Here, in a case where no operation to the operation switch 32 excluding the stopping switch 35 has not been performed (S22: N), the processing goes back to step S21 in order to continue the radio communication mode. In contrast to this, in a case where the operation to the operation switch 32 excluding the stopping switch 35 has been performed (S22: Y), the processing proceeds to step S23 and the confirmation screen is displayed on the information display screen 30. The confirmation screen is, but not particularly limited, at least for the user to confirm the intention of the switching to the switch operation mode. The processing further proceeds to step S24. In a case where the confirmation has been received from the user (S24: Y), the switching to the switch operation mode is performed. In a case where no confirmation has been received from the user or the intention of canceling has been indicated by the user (S24: N), the processing goes back to step S21 and the radio communication mode continues.

In a case where no radio communication with the telecommunication device 5 has been established in the radio communication mode, such as a case where the radio communication with the telecommunication device 5 has been interrupted when the electric motor drive control system 1 starts or when the switching to the radio communication mode is performed, the radio communication unit 36 attempts to establish the radio connection with the telecommunication device 5. That is, the radio communication mode can be regarded as a mode in which the radio communication unit 36 responds to the radio connection request from the telecommunication device 5 so as to establish the radio connection. In contrast to this, the switch operation mode can be regarded as a mode in which at least a driving instruction to the electric motor drive control device 2 can be issued through the operation switch 32, here, the driving switch 34.

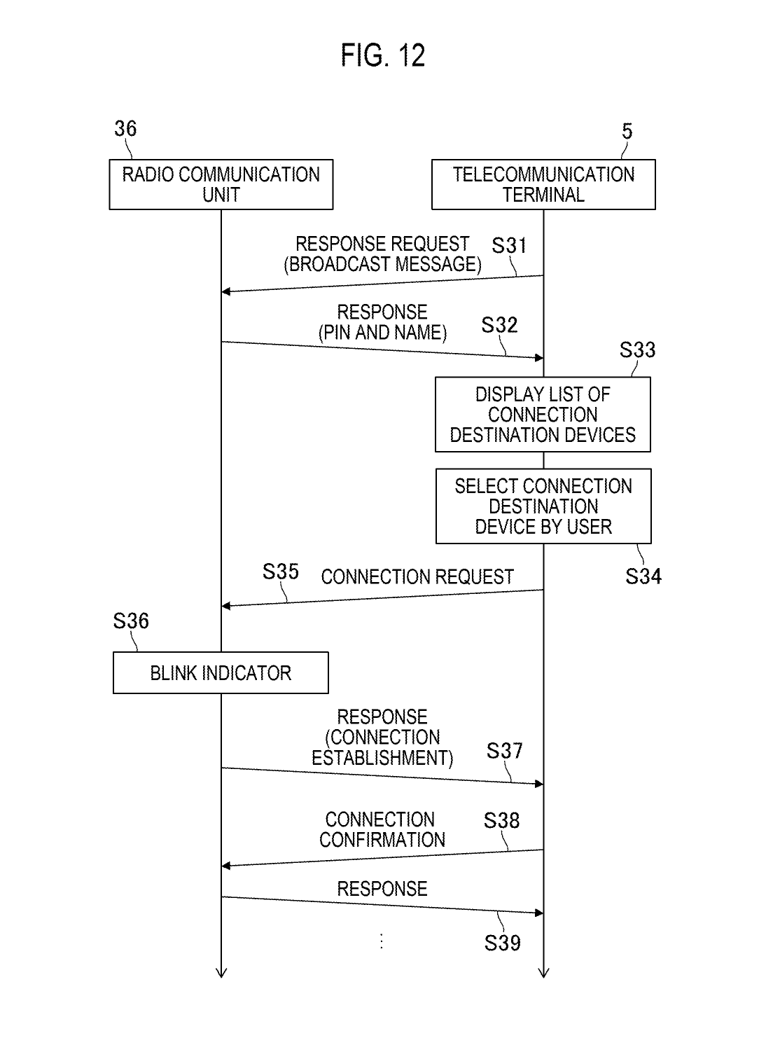

FIG. 12 is a flowchart of the operations of the radio communication unit 36 and the telecommunication device 5 in establishing the radio communication, in the radio communication mode.

In a state where no radio communication has been established, the radio communication unit 36 of the operation terminal 3 according to the present embodiment, acts as an observer and the telecommunication device 5 acts as a broadcaster, in the Bluetooth (registered trademark) standard. That is, the telecommunication device 5 transmits a message specifying no communication destination device (a broadcast message), and the radio communication unit 36 is ready to receive a message specifying no radio communication unit 36.

At step S31, the telecommunication device 5 first transmits a response request with the broadcast message. The response request includes ID specifying the telecommunication device 5 itself.

In a case where the operation terminal 5 in no connection and in the radio communication mode, is present in a communicable range with respect to the telecommunication device 5, at step S32, the radio communication unit 36 receives the response request and transmits a response. The response includes identification information with which the operation terminal 5 can be identified. The identification information, but not particularly limited, at least enables the individual of the operation terminal 5 to be identified. As such information, a PIN or a serial number may be used. The radio communication unit 36 according to the present embodiment, transmits, as the response, a device name, as the identification information, in addition to the PIN. The user freely may set the device name, and, for example, a name with which the use and position of the electric motor drive control system 1 can be easily identified, such as “elevator 1” or “elevator 2”, may be provided. The response may include a message specifying the telecommunication device 5 as a communication destination.

At step S33, the telecommunication device 5 that has received the response, displays a list of connection destination devices that have responded, on the GUI of the telecommunication device 5. This is because the number of the electric motor drive control systems 1 is not necessarily one in the communicable range of the telecommunication device 5 and a case where multiple responses are performed, is assumed. Since the list is based on the identification information included in the responses, the user can select which device that has responded, to perform the radio connection, with reference to the identification information. The radio communication unit 36 according to the present embodiment, transmits, as the response, the device name, as the identification information, in addition to the PIN, so that the user can select the connection destination device with the device name easily understood.

At step S34, the user selects one device from the list of the connection destination devices that have responded. After that, the telecommunication device 5 establishes the radio connection to the device that has been selected, so that the telecommunication device 5 acts as a master and the radio communication unit 36 of the electric motor drive control system 1 that has been specified, acts as a slave, in the Bluetooth (registered trademark) standard.

At step S35, the telecommunication device 5 further transmits a connection request to the radio communication unit 36 that has been specified. At step S36, the radio communication unit 36 that has received the connection request, blinks the indicator 31 of the operation terminal 3 to visually display that the electric motor drive control system 1 is the device that has been selected by the user and has received the connection request. With this arrangement, the user can remotely confirm whether the device with which the user desires the connection is actually a desired device, even performing the remote operation. If the device to which the connection request has been transmitted, is different from the desired device, the user at least operates the telecommunication device 5 to interrupt the radio connection and then restarts from step S31. The visual display at step S36 is not necessarily the blink of the indicator 36, and thus, but not particularly limited, at least enables the electric motor drive control system 1 to be confirmed remotely and visually as the particular device. That is, the operation terminal 5 at least includes a connection destination display unit that performs a connection destination display indicating that the electric motor drive control system 1 is the connection destination that has received the radio connection request from the telecommunication device 5. According to the embodiment, the indicator 31 corresponds to the connection destination display unit. As the connection destination display unit, the information display screen 30 may be used or a display device, such as a lamp, may be newly provided instead of the indicator 31. For example, an indicator or a lamp appropriately included in the electric motor drive control device 2, may be used as the connection destination display unit.

After that, at step S37, the radio communication unit 36 responds to the connection request so that the radio connection is established between the two. Then, a connection confirmation message is regularly transmitted from the telecommunication device 5 as illustrated at step S38 and the radio communication unit 36 transmits a response message to the connection confirmation message as illustrated at step S39, so that the radio connection state between the two is retained. If no connection confirmation message or no response message has been detected over a certain period of time, it is determined that the radio connection between the two has been interrupted.

According to the embodiment described above, as illustrated in FIG. 3, the mode setting unit 37 is provided to the operation terminal 3 and, as illustrated in FIGS. 4 and 6, the mode setting unit 37 passes or interrupts the information from each of the operation switch 32 and the telecommunication device 5 so that the information is transmitted to the electric motor drive control device 2 through the controller 38.

Therefore, the electric motor drive control device 2 at least operates regardless of whether the operation terminal 3 performs the radio communication. Thus, according to the present embodiment, a control device that uses an operation terminal premised on no radio communication, is directly used as the electric motor drive control device 2 and the operation terminal 3 according to the present embodiment is connected to the control device so that the electric motor drive control system 1 applicable to the radio communication can be constructed.

### Second Embodiment

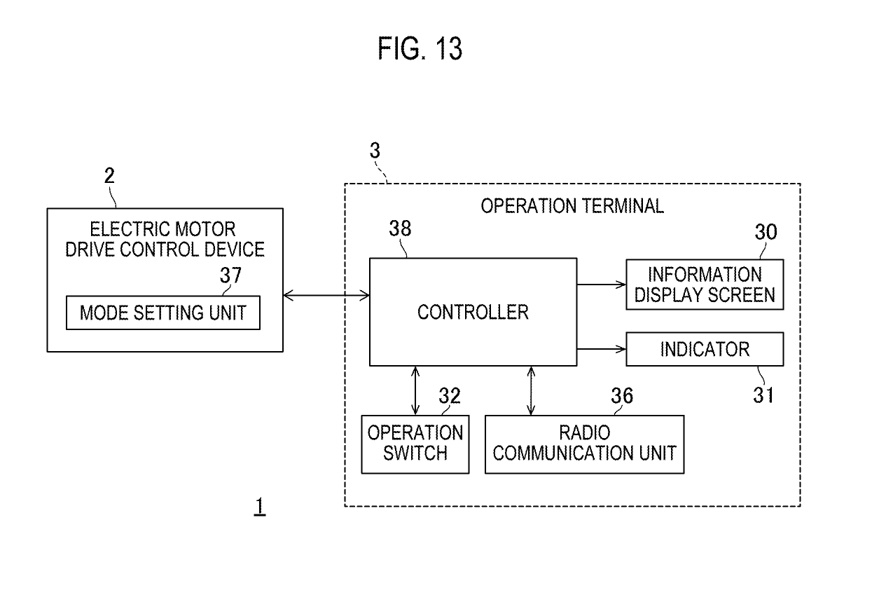

However, the present invention is not necessarily limited to the configuration according to the first embodiment described above. FIG. 13 is a functional block diagram of an electric motor drive control system 1 according to a second embodiment of the present invention. The present embodiment is different from the previous embodiment in that a mode setting unit 37 is provided to an electric motor drive control device 2 instead of being provided to an operation terminal 3.

According to the present embodiment, entire operation information input from an operation switch 32 and a radio communication unit 36, is transmitted to the electric motor drive control device 2 through a controller 38. The mode setting unit 37 performs is mode switching, and pass and interruption of the operation information as information processing inside the electric motor drive control device 2. Therefore, according to the present embodiment, the controller 38 controls the flow of the information, and the electric motor drive control device 2 performs almost all of the processing of the mode switching and generation of various images. Even with this configuration, the operation can be performed similarly to that according to the previous embodiment.

According to the present embodiment, the electric motor drive control device 2 itself has a configuration premised on radio communication, but the configuration of the operation terminal 3 and the information processing performed by the controller 38 are not intricate so that the cost of the operation terminal 3 itself can be reduced. That is, in a case where the throughput of an information processing circuit included in the electric motor drive control device 2 is sufficiently high and the information processing circuit not only can control an inverter circuit but also manage the mode switching in the radio communication, there is an advantage that the cost of the entire electric motor drive control system 1 can be reduced in comparison to that according to the previous embodiment.

### Third Embodiment

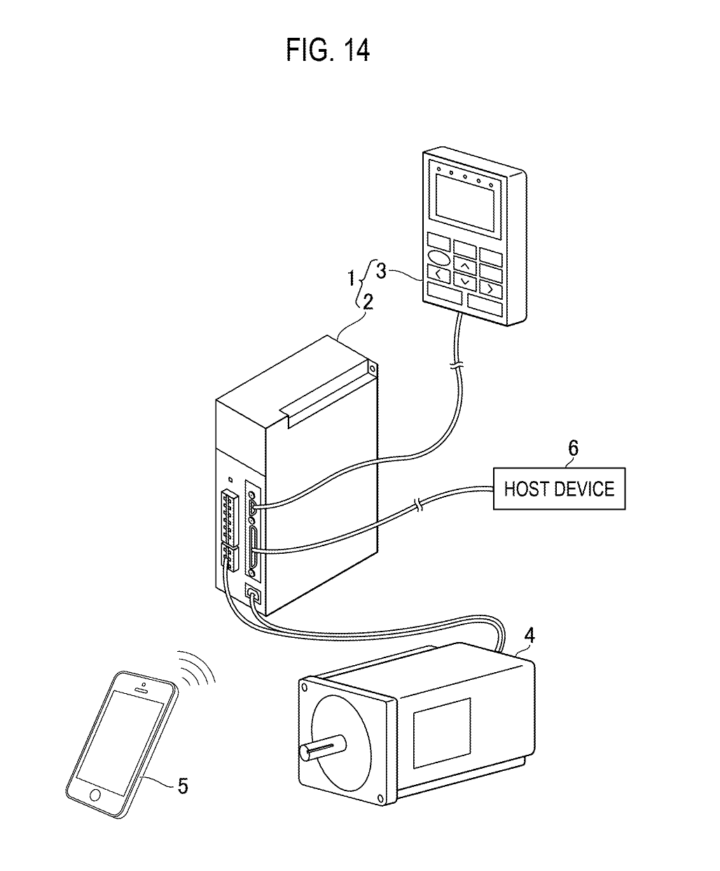

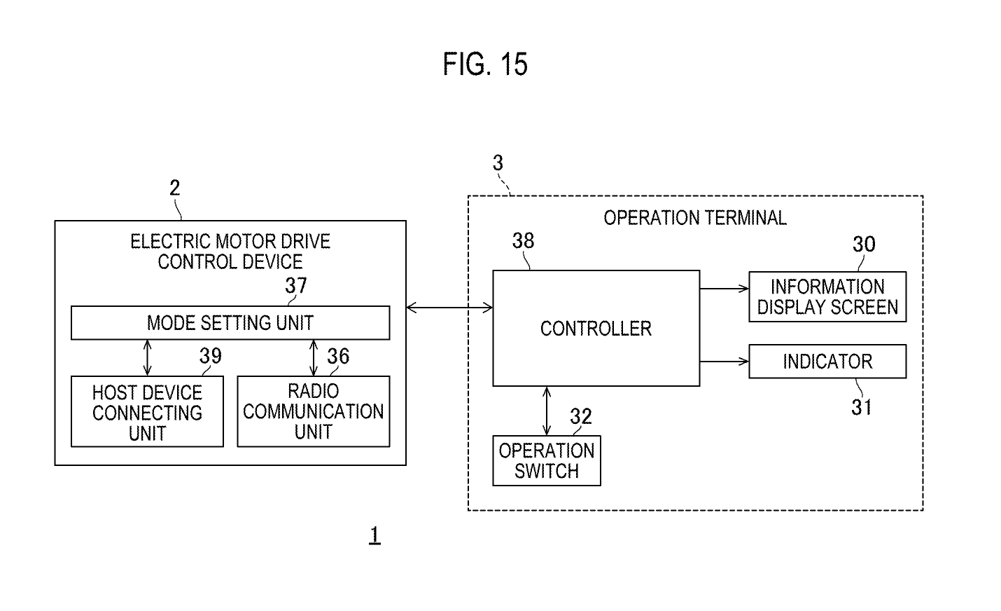

FIG. 14 is a view of a system configuration for electric motor control, including an electric motor drive control system 1 according to a third embodiment of the present invention. FIG. 15 is a functional block diagram of the electric motor drive control system 1 according to the third embodiment of the present invention.

According to the present embodiment, an electric motor drive control device 2 includes a so-called servo controller, and may be used being connected to a host device 6, such as a programmable logic controller (PLC) as illustrated. Here, the host device 6 is an automation device that issues a command to the electric motor drive control device 2 to make the electric motor control device 2 perform a predetermined operation. Examples of the predetermined operation performed by the electric motor control device 2 include execution of a previously set program and alteration of a setting value in the electric motor control device 2.

A device that issues a manual command of a user with respect to the electric motor drive control device 2, is directly or indirectly connected to the electric motor drive control device 2. Here, the indirect connecting means that connecting is performed to enable information and communication mutually through a telecommunication line. Examples of the manual command of the user include a command for driving an electric motor 4, a command for setting parameters in the electric motor drive control device 2, and a command for displaying the parameters and state of the electric motor drive control device 2, but exclude a command for automation performed in accordance with a previously created program. The device that issues the manual command of the user with respect to the electric motor drive control device 2, is referred to as a manual command device.

A digital operator illustrated in FIG. 14 includes an exemplary operation terminal 3 being an exemplary manual command device. Through the operation terminal 3, the user issues the various commands to the electric motor drive control device 2 to operate the electric motor 4 or the electric motor drive control device 2, and additionally receives a display of various types of information from the electric motor drive control device 2. Here, the operation terminal 3 is not necessarily constantly required to operate the system for the motor control as illustrated in FIG. 14, and thus may be connected to the electric motor drive control device 2 only when necessary. That is, while steady driving is being performed, the operation terminal 3 is not connected with the electric motor drive control device 2, and the electric motor drive control device 2 operates in accordance with the command from the host device 6.

The manual command device is not limited to the operation terminal 3 described above, and thus may include a device through which the user can issue the manual command. For example, in a case where the PLC being the host device 6 has a function with which the user issues the manual command, the host device 6 corresponds to the manual command device. Alternatively, in a case where a different device, such as a computer with which a servo program is previously written, is further connected to the electric motor drive control device 2 and the user can issue the manual command with the computer, the computer corresponds to the manual command device. The electric motor drive control device 2 may be connected to one or different manual command devices, instead of or in addition to the operation terminal 3.

The electric motor 4 includes a servo motor, here. As illustrated in FIG. 15, according to the present embodiment, the electric motor drive control device 2 includes a radio communication unit 36 in addition to a mode setting unit 37. Therefore, the operation terminal 3 includes neither the mode setting unit 37 nor the radio communication unit 36 provided. The electric motor drive control device 2 performs radio communication with a telecommunication device 5 through the radio communication unit 36 included in the electric motor drive control device 2. The electric motor drive control device 2 further includes a host device connecting unit 39, and is connected with the host device 6 so as to be able to perform information and communication. The host device connecting unit 39 may include a dedicated interface for connecting with the particular host device 6, or a general-purpose communication interface, such as Mechatrolink (trademark). The mode setting unit 37 can individually limit the information and communication with the operation terminal 3, the radio information and communication with the telecommunication device 5, and the information and communication with the host device 6, in accordance with modes.

The basic operation of the mode setting unit 37 is similar to that according to the previous embodiment. In a switch operation mode, the radio communication of the radio communication unit 36 is turned off so that no radio communication is performed or, with a few exceptions, such as a stopping instruction, the mode setting unit 37 interrupts information input from the radio communication unit 36. In a radio communication mode, conversely, with the few exceptions, such as an operation of a stopping switch, the mode setting unit 37 interrupts information on an operation performed by the user with respect to an operation switch 32 of the operation terminal 3. In the switch operation mode, in a case where no operation to the operation switch 32 has been performed for a certain period of time, switching to the radio communication mode is automatically performed.

The mode setting unit 37 handles the input of the manual command from the host device 6 or the different manual command device as in the switch operation described above, so as to perform mode setting. That is, in a case where no input of the manual command has been performed for the certain period of time as in the switch operation, the switching to the radio communication mode is automatically performed. The switch operation to the operation terminal 3, is an exemplary manual command.

In the radio communication mode, the information and communication from the telecommunication device 5 is prioritized, and the mode setting unit 37 interrupts the manual command including the information on the operation performed by the user with respect to the operation switch 32 so that the manual command is not received by the electric motor drive control device 2. As in the description according to the previous embodiment, an exemplary manual command, for example, a command for stopping the electric motor 4, such as the operation to the stopping switch 35, or a command for switching the mode to the switch operation mode, may be permitted with the information and communication not interrupted.

The mode setting unit 37 may allow a command except the manual command, such as the automation command relating to the automation from the host device 6, to be received by the electric motor drive control device 2, with the information and communication not interrupted regardless of the mode. With this arrangement, while the electric motor drive control device 2 is automatically operating in accordance with the command from the host device 6, the radio connection with telecommunication device 5 can be established so that the state of the electric motor drive control device 2 under the automation can be monitored.

Alternatively, in the radio communication mode, the mode setting unit 37 may interrupt the information and communication for the automation command relating to the automation from the host device 6. In that case, an unexpected operation can be prevented from occurring due to alteration of the parameters performed by the user to the electric motor drive control device 2 under the automation.

Meanwhile, in the switch operation mode, as in the description according to the previous embodiment, the radio communication is turned off so that no radio communication is performed or, with the few exceptions, the mode setting unit 37 interrupts the information input from the radio communication unit 36 so that the information is not received by the electric motor drive control device 2. Thus, in the switch operation mode, the point that the telecommunication device 5 outside cannot operate the electric motor drive control device 2 in principle, may be provided similarly.

As the electric motor drive inverter, there is a type of electric motor drive inverter that is connected to, for example, a small-sized operation terminal referred to as a keypad, to perform an operation of the device, an alteration in control parameters, and a display of internal information, through the operation terminal. The operation terminal includes an information display screen, such as a liquid crystal display, that displays information, and various buttons that each receive an input operation from a user. The operation terminal is connected to the electric motor drive inverter directly through a connector or physically through a telecommunication cable.

As the operation terminal, there is a type of operation terminal capable of remote operation in radio connection with a mobile telecommunication device, such as a so-called smartphone. For example, Assistant Control Panel ACS-AP-W sold by ABB Inc., is capable of radio connection with a smartphone through Bluetooth (registered trademark). With the ACS-AP-W, operating a specific button on the operation terminal, displays numbers on a screen, and then inputting the numbers onto the smartphone, establishes the radio connection. During the connection with the smartphone, various operations to the electric motor drive inverter are performed through the smartphone and a button operation on the operation terminal is invalidated.

In addition, a servo controller has been widely used as a device capable of controlling the position and speed of an electric motor freely, and the electric motor controlled by the servo controller is referred to as a servo motor. As the servo controller, there is a type of servo controller that is connected to a digital operator being a small-sized operation terminal, to perform an operation of the device, an alteration in control parameters, and a display of internal information, similarly to the keypad for the electric motor drive inverter.

An electric motor drive control system according to an embodiment of the present invention enables remote connection and an operation from a telecommunication device to require no direct operation to an operation terminal in an electric motor drive control system.

An electric motor drive control system according to an embodiment of the present invention includes an electric motor drive control device and a manual command device that issues a manual command to the electric motor drive control device. The electric motor drive control system includes: a radio communication unit that performs radio communication with a telecommunication device to be a radio connection destination; and a mode setting unit that sets a radio communication mode in which the radio communication unit responds to a radio connection request from the telecommunication device to establish radio connection, in a case where the manual command device issues no manual command.

In the electric motor drive control system according to an aspect of the present invention, the manual command device may be an operation terminal including an operation switch, the operation terminal being physically connected to the electric motor drive control device. The mode setting unit may set the radio communication mode in a case where no operation to the operation switch is performed.

In the electric motor drive control system according to another aspect of the present invention, the mode setting unit may perform, with a particular operation to the operation switch in the radio communication mode, switching to a switch operation mode in which a driving instruction to the electric motor drive control device is at least allowed to be issued with the operation switch. The mode setting unit may perform switching to the radio communication mode in a case where no operation to the operation switch is performed for a certain period of time in the switch operation mode.

In the electric motor drive control system according to another aspect of the present invention, the operation switch may include a stopping switch that issues an instruction for stopping an electric motor. An operation to the stopping switch may be effectively received even in the radio communication mode.

In the electric motor drive control system according to another aspect of the present invention, the operation terminal further includes an information display screen. The operation switch may further include a driving switch that issues an instruction for driving the electric motor. The mode setting unit may display, on the information display screen, a confirmation display for a user to confirm the switching to the switch operation mode, in a case where an operation to the driving switch is performed as the particular operation in the radio communication mode, and perform the switching to the switch operation mode immediately in a case where the operation to the stopping switch is performed as the particular operation in the radio communication mode.

In the electric motor drive control system according to another aspect of the present invention, the mode setting unit may limit, when the particular operation to the operation switch is performed in the switch operation mode, the transition from the switch operation mode to the radio communication mode in the case where no operation to the operation switch is performed for the certain period of time.

In the electric motor drive control system according to another aspect of the present invention, the mode setting unit may perform, in the switch operation mode, the switching to the radio communication mode in accordance with a mode change request from the telecommunication device in the radio connection.

In the electric motor drive control system according to another aspect of the present invention, a stopping instruction for the electric motor from the telecommunication device in the radio connection, may be effectively received even in the switch operation mode.

In the electric motor drive control system according to another aspect of the present invention, the radio communication unit may transmit identification information with which the operation terminal is identified, to the telecommunication device.

The electric motor drive control system according to another aspect of the present invention may further include a connection destination display unit that performs a connection destination display indicating that the electric motor drive control system is a connection destination that has received the radio connection request, in a case where the radio communication unit receives the radio connection request from the telecommunication device.

In the electric motor drive control system according to another aspect of the present invention, the operation terminal may include the radio communication unit and the mode setting unit.

In the electric motor drive control system according to another aspect of the present invention, wherein the operation terminal may include the radio communication unit. The electric motor drive control device may include the mode setting unit.

In the electric motor drive control system according to another aspect of the present invention, the electric motor drive control device may include the radio communication unit and the mode setting unit.

A driving instruction method according to another aspect of the present invention is a method of an electric motor drive control device in an electric motor drive control system including the electric motor drive control device and a manual command device that issues a manual command to the electric motor drive control device. The driving instruction method includes performing switching to a radio communication mode in a case where the manual command is not issued for a certain period of time in a switch operation mode. In the switch operation mode, a driving instruction to the electric motor drive control device is allowed to be issued with the manual command. In the radio communication mode, a response is made to a radio connection request from a telecommunication device through radio communication to establish radio connection.

Obviously, numerous modifications and variations of the present invention are possible in light of the above teachings. It is therefore to be understood that within the scope of the appended claims, the invention may be practiced otherwise than as specifically described herein.

1. An electric motor drive control system, comprising:
an electric motor drive control device;
a manual command device connected to the electric motor drive control device;
a radio configured to perform radio communication with a telecommunication device that is a radio connection destination; and
processing circuitry configured to set a radio communication mode in which the radio responds to a radio connection request from the telecommunication device to establish a radio connection, the radio communication mode being set when the manual command device issues no manual command.

2. The electric motor drive control system according to claim 1, wherein the processing circuitry is further configured to perform, in response to a particular operation to the manual command device in the radio communication mode, switching to a switch operation mode in which a driving instruction to the electric motor drive control device is permitted to be issued from the manual command device, and perform switching to the radio communication mode when no operation to the manual command device is performed for a certain period of time in the switch operation mode.

3. The electric motor drive control system according to claim 2, wherein the manual command device is an operation terminal including an operation switch and being physically connected to the electric motor drive control device, and the processing circuitry is further configured to set the radio communication mode when no operation to the operation switch is performed.

4. The electric motor drive control system according to claim 3, wherein the operation switch includes a stopping switch that generates an instruction for stopping an electric motor, and an instruction from the stopping switch is effectively received even in the radio communication mode.

5. The electric motor drive control system according to claim 4, wherein the operation terminal further includes an information display screen, the operation switch further includes a driving switch that generates an instruction for driving the electric motor, and the processing circuitry is further configured to control display, on the information display screen, of a confirmation display for a user to confirm the switching to the switch operation mode when an operation to the driving switch is performed as the particular operation in the radio communication mode, and perform the switching to the switch operation mode immediately when the operation to the stopping switch is performed as the particular operation in the radio communication mode.

6. The electric motor drive control system according to claim 3, wherein the processing circuitry is further configured to limit, when the particular operation to the operation switch is performed in the switch operation mode, the transition from the switch operation mode to the radio communication mode when no operation to the operation switch is performed for the certain period of time.

7. The electric motor drive control system according to claim 1, wherein the processing circuitry is further configured to perform, in the switch operation mode, the switching to the radio communication mode in accordance with a mode change request from the telecommunication device via the radio connection.

8. The electric motor drive control system according to claim 1, wherein a stopping instruction for the electric motor from the telecommunication device via the radio connection, is effectively received even in the switch operation mode.

9. The electric motor drive control system according to claim 1, wherein the radio is configured to transmit identification information, by which the manual command device is identified, to the telecommunication device.

10. The electric motor drive control system according to claim 9, further comprising:
indicator circuitry configured to perform a connection destination display indicating that the radio connection request has been received when the radio receives the radio connection request from the telecommunication device.

11. The electric motor drive control system according to claim 1, wherein the manual command device includes the radio and the processing circuitry.

12. The electric motor drive control system according to claim 1, wherein the manual command device includes the radio, and the electric motor drive control device includes the processing circuitry.

13. The electric motor drive control system according to claim 1, wherein the electric motor drive control device includes the radio and the processing circuitry.

14. The electric motor drive control system according to claim 1, wherein the manual command device issues a manual command to the electric motor drive control device.

15. A driving instruction method implemented by an electric motor drive control system, comprising:
performing switching to a radio communication mode when a manual command is not issued for a certain period of time in a switch operation mode;
permitting, in the switch operation mode, a driving instruction to an electric motor drive control device to be issued with the manual command; and
performing, in the radio communication mode, a response to a radio connection request from a telecommunication device through radio communication to establish a radio connection,
wherein the electric motor drive control system includes the electric motor drive control device and a manual command device connected to the electric motor drive control device.

16. A mode setting apparatus, comprising:
memory; and
processing circuitry configured to set a radio communication mode in which a radio, configured to perform radio communication with a telecommunication device that is a radio connection destination, responds to a radio connection request from the telecommunication device to establish a radio connection, the radio communication mode being set when a manual command device, connected to an electric motor drive control device, issues no manual command.

17. The mode setting apparatus according to claim 16, wherein the processing circuitry is further configured to perform, in response to a particular operation to the manual command device in the radio communication mode, switching to a switch operation mode in which a driving instruction to the electric motor drive control device is permitted to be issued from the manual command device, and perform switching to the radio communication mode when no operation to the manual command device is performed for a certain period of time in the switch operation mode.

18. The mode setting apparatus according to claim 17, wherein the manual command device is an operation terminal including an operation switch and being being physically connected to the electric motor drive control device, and the processing circuitry is further configured to set the radio communication mode when no operation to the operation switch is performed.

19. The mode setting apparatus according to claim 18, wherein the operation switch includes a stopping switch that generates an instruction for stopping an electric motor, and an instruction from the stopping switch is effectively received even in the radio communication mode.

20. The mode setting apparatus according to claim 18, wherein the operation terminal further includes an information display screen, the operation switch further includes a driving switch that generates an instruction for driving the electric motor, and the processing circuitry is further configured to control display, on the information display screen, of a confirmation display for a user to confirm the switching to the switch operation mode when an operation to the driving switch is performed as the particular operation in the radio communication mode, and perform the switching to the switch operation mode immediately when the operation to the stopping switch is performed as the particular operation in the radio communication mode.
